(19) United States
(12) Patent Application Publication
(10) Pub. No.: US 2003/0050818 A1
(43) Pub. Date: Mar. 13, 2003

(54) Production managing system

(76) Inventors: Tomoko Maie, Tsuchiura (JP); Kiyomitsu Ogawa, Abiko (JP); Hiroshi Miyamoto, Moriya (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/090,758

(22) Filed: Mar. 6, 2002

(30) Foreign Application Priority Data
Sep. 7, 2001 (JP) 2001-280902

(51) Int. Cl. G06F 17/60

(52) U.S. Cl. 705/8

(57) ABSTRACT

A production reservation system is provided with an estimate supporting system and a generating part of a production reservation calendar. A sales department inputs order information in the estimate supporting system. A production time period in a production department is reserved in the generating part of the production reservation calendar in response to the order information entered in the estimate supporting system. The generating part of the production reservation calendar contains a delivery appointed date calendar and a manufacture date calendar. While using order data of an order information system which stores thereinto a change in order information, the production reservation system reserves and confirms a manufacture time period of a production line at an earlier stage.

### BACKGROUND OF THE INVENTION

The present invention generally relates to a production reservation system for reserving production schedule of products. More specifically, the present invention is directed to such a production reservation system suitably for order-accepted production.

In order-accepting production, in which there are many sorts of technical specifications requested by customers, it is strongly required to product equally day by day and to product just in time (JIT) as the customers requested in order to improve production efficiency. Under such a circumstance, examples of methods capable of improving the production efficiency are described in JP-A-2001-100832 and JP-A-2001-51710.

JP-A-2001-100832 describes the delivery appointed date calculating system in order to quickly calculate the executable delivery appointed date, while the actual stage loads of the production are calculated. This delivery appointed date calculating system is provided with the order managing unit for managing the products ordered by the customers, the capability frame managing unit for grasping the production capability with respect to each of the production lines, and also the scheduled delivery date calculating unit for judging as to whether or not the production capability available until the delivery appointed date is sufficiently usable with respect to the amount of such orders.

JP-A-2001-051710 describes the production management system in order to optimally utilize stocks existed in the production stage. Namely, in this production management system, in such a case that the parts use amount requested by the design division is smaller than the stock amount, this requested parts use amount may be employed. To the contrary, when the parts use amount requested by the design division is larger than the stock amount, the requested due date at the earlier stage is replaced by the requested due date at the later stage to be employed based upon the due date requested by the design division.

In the above-explained delivery appointed date calculating system of the ordered products as described in JP-A-2001-100832, since the executable delivery appointed date is quickly calculated by grasping the production capability of each of the production lines at this stage, the delivery appointed date can be immediately responded when the order is accepted. However, this delivery appointed date calculating system does not consider variations contained in increased/decreased order amounts. Generally speaking, in order-accepted production, an amount of orders is varied, because there are many sorts of technical specifications, and also, such a high-precision order predicting method established in a mass-production product cannot be established. As a consequence, this delivery appointed date calculating system owns such a problem that the production cannot be equalized throughout a year and also has a problem that the delivery appointed date cannot be answered to the customer at once.

In the production managing system described in JP-A-2001-51710, since the stocked products are successively used in this order from such a product whose use urgent degree is high, the excess stock can be avoided and also the lead-time can be reduced. However, this production management system cannot sufficiently consider to solve such a problem that the amount of orders is changed and thus, the production amount is brought into non-uniform throughout a year.

### SUMMARY OF THE INVENTION

The present invention has been made to solve the above-described problems of the above-explained prior art, and therefore, has an object to reserve production at once in order-accepted production. Another object of the present invention is to equalize production throughout a year in the order-accepted production.

To achieve the above-described objects, a production reservation system, according to an aspect of the present invention, is featured by such a production reservation system for reserving production of an article based upon an estimate information of a sales department, comprising: a supporting system for estimate in which the sales department inputs the estimate information; and a generating part of a production reservation calendar in which a production schedule in a production reservation calendar is reserved in response to the estimate information inputted in the estimate supporting system, wherein a mass of production that is determined based on a capability of production in the production department has inputted to the production calendar in advance.

In this featured production reservation system, it is preferable that the estimate information from the sales department is inputted into the estimate supporting system by employing either the Internet or a public telephone line; the estimate information from the sales department contains a certainty degree of an order, and said generating part of a production reservation calendar calculates the production schedule based upon said certainty degree of the order and enables to show a completion date of the article at a time the sales department inputs the estimate information; said generating part of a production reservation calendar comprises a manufacture date calendar which is generated based on the estimate information inputted to said support system for estimate, and generates a parts completion date calendar which is supplied to a parts maker with employment of both a providing period assigned by respective parts and said manufacturing calendar; said generating part of a production reservation calendar comprises a manufacture date calendar which is generated based on the estimate information inputted to said support system for estimate, and generates a manufacture stage calendar which is supplied to a manufacture department with employment of said manufacture date calendar; the case that the reservation information is changed into “no order”, said generating part of a production reservation calendar cancels the reservation and reserves another article.

To achieve the above-described objects, a production reservation system, according to a still further aspect of the present invention, is featured by such a production reservation system for reserving production of an article based upon an estimate information of a sales department comprising: a supporting system for estimate which stores thereinto the estimate information containing a requested due date inputted by the sales department; and a generating part of a production reservation calendar reserving a production schedule in a production reservation calendar based on the estimate information inputted to said supporting system for estimate, wherein said generating part of the production reservation calendar reserves the production into one of empty seats of the production reservation calendar which is calculated based on a standard time period required for supply of parts and manufacturing set up to a standard article, an optional time period needed for a modified article modified from the standard article and delivery time period for delivering the article.

In this featured production reservation system, it is preferable that the generating part of the production reservation calendar reserves a production into one of the empty seats located before the requested due date by more than the delivery due date and located after elapsing a summed period of the standard time period originated from inputting the estimate information by the sales division and the optional time period; the generating part of the production reservation calendar reserves the production into an empty seat of the production reservation calendar which is located nearest the requested due date; the generating part of the production reservation calendar reserves the production into an empty seat of the production reservation calendar which locates nearest the requested due date and after the requested due date when no empty seat is found before the requested due date; the case that the reservation information is changed into “no order”, said generating part of a production reservation calendar cancels the reservation and reserves another article.

In other words, in accordance with the present invention, the sales department, the manufacture department and also, the parts supplier can commonly use the data, and furthermore, can commonly utilize these data. Another feature of the present invention is to be able to reserve the product schedule in an order-accepted production according to estimate information from the sales division as if it will be produced by an assembly-line system.

Other objects, features and advantages of the invention will become apparent from the following description of the embodiments of the invention taken in conjunction with the accompanying drawings.

### BRIEF DESCRIPTION OF THE DRAWINGS

For a better understanding of the present invention, reference is made of a detailed description in conjunction with the accompanying drawings, in which:

FIG. 1 is a schematic block diagram for representing an estimate supporting system according to one embodiment provided with a production reservation system of the present invention;

FIG. 2 is a schematic diagram for indicating a relationship between the estimate supporting system and a generating part of a production reservation calendar shown in FIG. 1;

FIG. 3 is a diagram for schematically showing a delivery appointed date calendar provided in the product reservation system of the present invention;

FIG. 4 is a schematic diagram for representing a mutual relationship among the respective systems provided in the production reservation system of the present invention;

FIG. 5 is a diagram for schematically showing a reservation sequence executed in the production reservation system of the present invention;

FIG. 6 is an illustration for illustratively showing an example of a reservation process operation executed in the production reservation system of the present invention;

FIG. 7 is an illustration for illustratively indicating another example of the reservation process operation executed in the production reservation system of the present invention;

FIG. 8 is an illustration for illustratively showing a further example of the reservation process operation executed in the product reservation system of the present invention;

FIG. 9 is a schematic diagram for representing a production reservation system of the present invention;

FIG. 10 is a structural diagram for indicating one partial structure of a generating part of a production reservation calendar provided in the production reservation system of the present invention; and

FIG. 11 is a structural diagram for representing another partial structure of the generating part of a production reservation calendar provided in the production reservation system of the present invention.

### DESCRIPTION OF THE INVENTION

A production reservation system, according to the present invention, is mainly featured by employing a generating part of a production reservation calendar. Referring now to drawings, an embodiment of the production reservation system will be explained. In this embodiment, production of refrigerators is managed in accordance with this production reservation system. With respect to order-accepted products such as refrigerators there are many possibilities that requested due dates are concentrated on the same days before cooling demand or warming demand. To satisfy these requested due dates working hours of a production department may be sometime extended. However, when an excessive amount of product orders is requested, apparently, delivery dates as to a certain product of the entire ordered products are delayed. Also, a price should be increased due to overloads given to this production department.

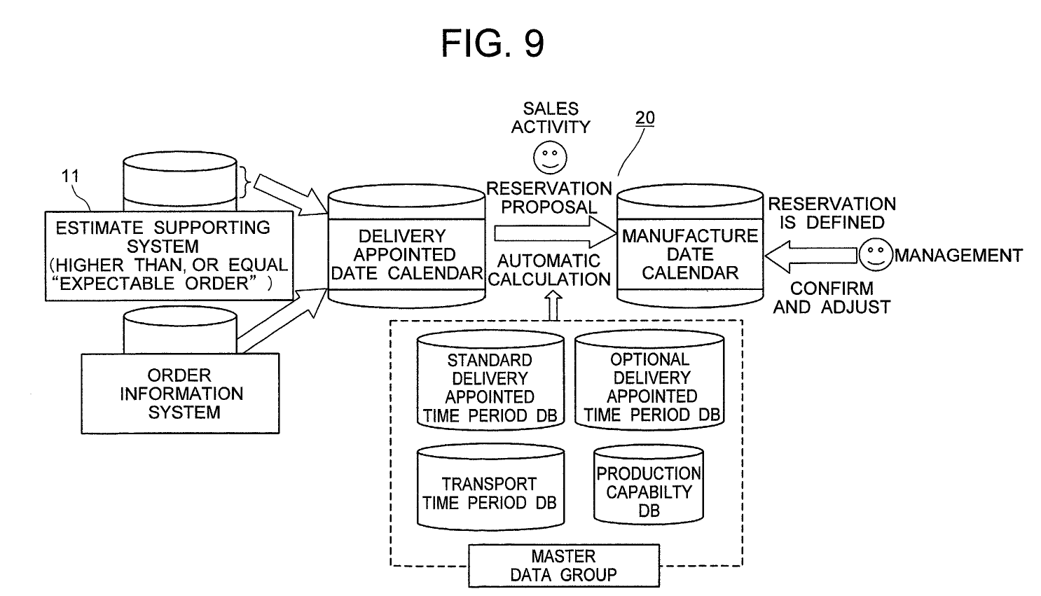

As a consequence, in this embodiment, a production reservation system shown in FIG. 9 is employed. In the case of medium-sized/large-sized refrigerators, a staff of a sales department performs sales activities of estimates as order-requiring activities before the staff of sales department actually accepts orders of refrigerator products. The production reservation system automatically reserves production based on an information got from the sales activities of estimates (will be referred to as “estimate information” hereinafter). A detailed content of this production plan will now be described as follows.

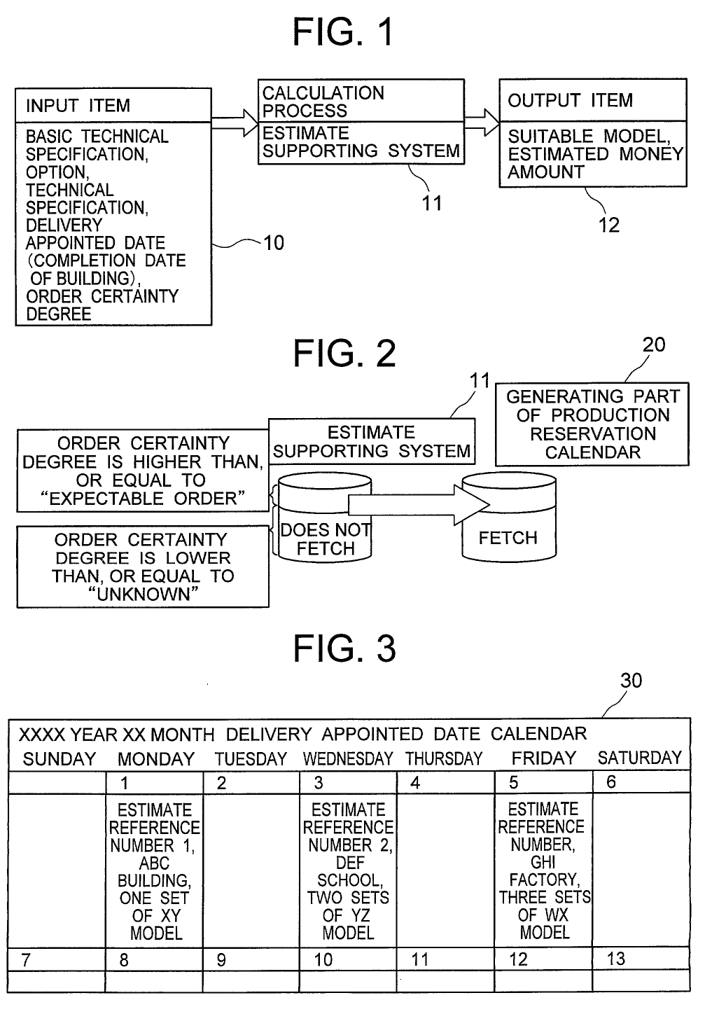

FIG. 1 briefly shows an estimate supporting system 11 employed in the case that staff of a sales department performs sales activities. This sales department acquires technical information 10 required for an estimate with reference to the estimate supporting system 11, while staff of a management department registers this technical information in this estimate supporting system 11. In this case, the sales department inputs a technical specification to the estimate support system, requested by a customer so as to automatically select a model of a product that may be fitted to an inquiry of the customer, or to select a necessary option.

Furthermore, the sales department inputs either a delivery appointed date requested by the customer or completion time of a building which may store a refrigerator product so as to grasp such a delivery appointed date which may satisfy the request of this customer. In addition, the sales department judges a certainty level of an order as an index and enters this judged certainty level into the estimate supporting system 11, while this index indicates how certain an estimated product may be ordered by the customer. The certainty levels of orders are defined by “uncertain”, “expectable order”, “definite order,”—in order from low levels. Since this certainty level of the order is apparently changed in progress of order-requiring activities, the certainty level may be changed/corrected time to time.

As indicated in FIG. 2, in such a case that an order certainty level of the estimate supporting system indicates such an index higher than, or equal to “expectable order”, the estimate information that is entered into the estimate supporting system by the sales department is fetched into a generating part of a production reservation calendar 20. In the case that the order certainty level indicates such a low index as “uncertain”, the estimate information is not fetched into the generating part of the production reservation calendar 20. The reason why this estimate information is not fetched is given as follows. That is, the sales department promotes maintenance of order certainty in order to increase precision of demand predictions.

The estimate information acquired in the generating part of the production reservation calendar 20 is rearranged as production reservation subject data in the order of delivery appointed dates. When a completion date of a building used to store thereinto a refrigerator is not known, the sales department predicts completion time of this building and then enters this predicted completion time into the estimate supporting system. When the completion time of the building is entered, the generating part of the production reservation calendar 20 automatically registers such a date before two months from the completion time of this building as a provisional delivery appointed date. After order articles and order-scheduled articles are rearranged in the order of delivery appointed dates thereof, these rearranged articles are displayed on a display apparatus (not shown) provided in the system. When these rearranged articles are displayed, these articles are indicated in such a calendar format as shown in FIG. 3 in order to easily and visibly understand that how many requested delivery appointed items are concentrated on the same date. This is called as a “delivery appointed date calendar.” In this delivery appointed date calendar 30, estimate reference numbers, installation places, model of delivered machines, and the like are indicated. The entered estimate articles in the same day are limited by a capability of the manufacturing division and inputted to the delivery appointed date calendar in advance by the managing division.

The delivery appointed date calendar indicates such data that the order certainty levels of the estimate supporting system are selectively defined by “expectable order”, or the higher order articles. Even if the order article is limited to this order certainty level, when there are many data, extraction conditions of data may be added thereto and the condition-added data may be displayed. Based upon the added extraction condition, calendars with respect to the respective sales staff members, calendars as to the respective sales departments, calendars as to the respective types of machines are obtained. As a result, such data that is wanted to be reserved can be quickly searched from a large amount of data. The delivery appointed data calendar indicates not only data which are acquired at estimate stages from the estimate supporting system, but also order information in systematic connection with the order information system.

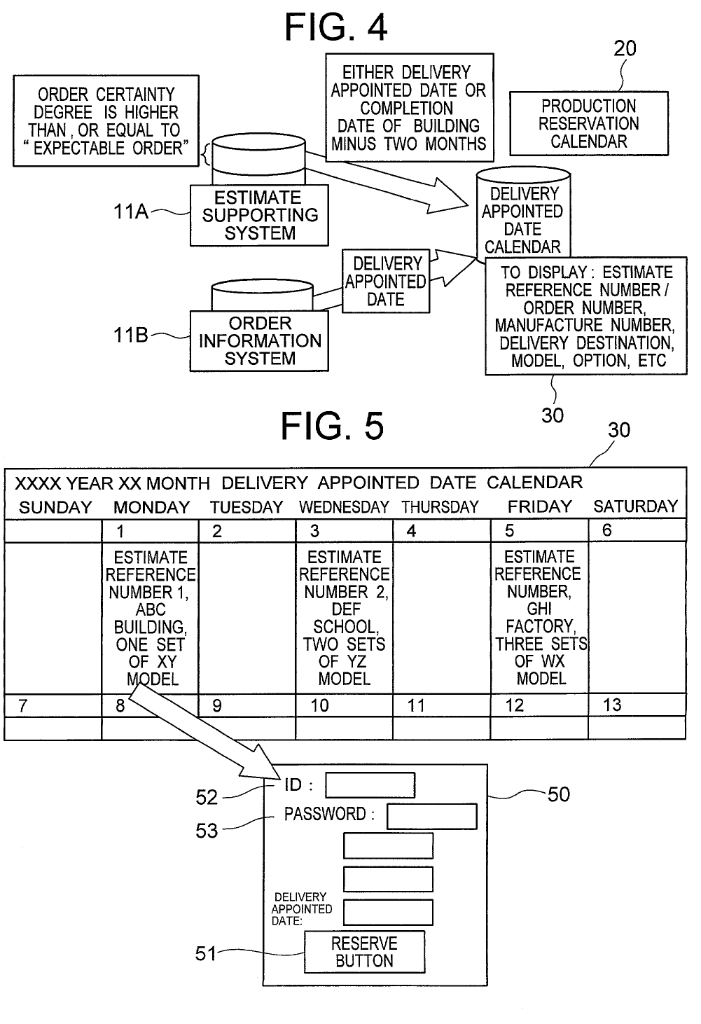

An operation flow is shown in FIG. 4 in which a state of an estimate article is changed to an order state. FIG. 4 is a schematic diagram for indicating a relationship among the respective systems employed when an order is received. Upon receipt of an estimate request article, both an order number and the respective information as to a product manufacture are inputted into the order information system. In connection with this data entry, operations of a delivery and an order about parts/components required for this product are commenced. Order numbers are applied to the estimate information that has been stored in the estimate supporting system. Since these order numbers are unified with the order numbers of the order information system, the data are mutually coupled to each other.

Manufacture numbers corresponding to the order numbers are entered into the order information system which is used for a management unit numbers. This manufacture number may be utilized so as to manage manufacturing operations by a manufacture department, and/or to manage manufacturing operations by parts supply makers. Since such detailed data as optional parts are registered only into the estimate supporting system, when an estimate request article is received, such detailed data of the estimate supporting system are succeeded by the order information system as order data.

If these data are not succeeded, then the manufacture of the product cannot be correctly instructed to the manufacture department, and/or the order to the parts supply maker cannot be correctly issued. Either a delivery appointed date sent from the estimate supporting system or such a delivery appointed date which is set before two months from the completion time of the building is automatically set and is indicated in the delivery appointed date calendar.

FIG. 5 illustratively shows a reservation sequential indicated in the delivery appointed date calendar. The sales department selects the reservation article from an order information or an estimate information indicated in the delivery appointed date calendar and generates a manufacturing date calendar. A changed requested delivery date is inputted into the reservation calendar when the requested delivery date was changed from an estimate state till an order state. The sales department clicks a button shown on a display screen provided with this production reservation system, and then a reservation procedure is executed. In this procedure, data security is confirmed by inputting an identification (ID) and a password assigned beforehand.

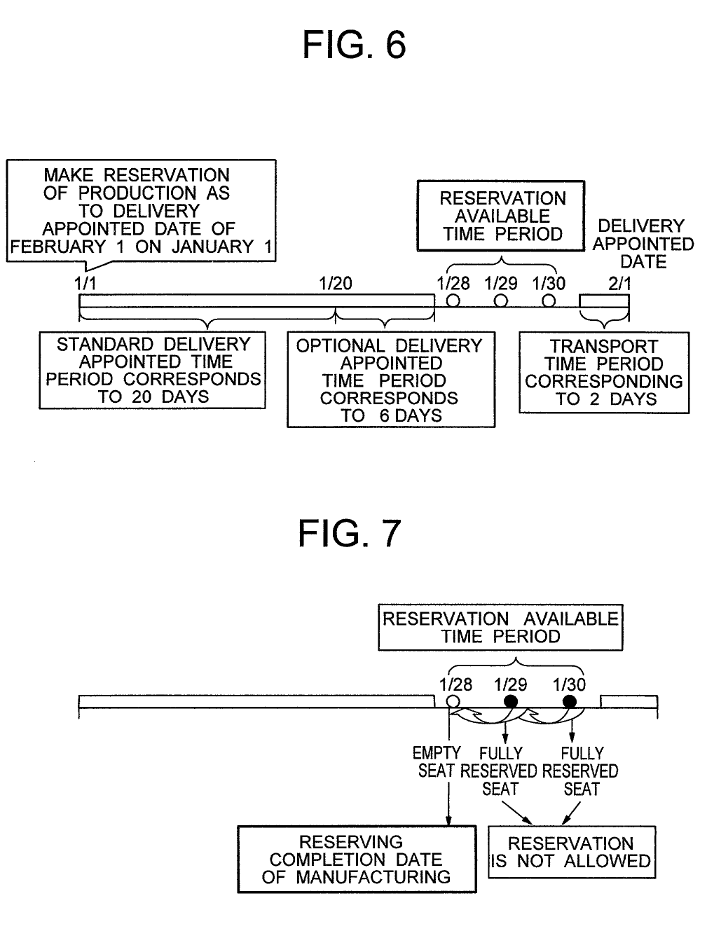

As the reserve button is clicked, a computer is provided with the production reservation system automatically seeks such a date that the required delivery appointed date can be satisfied and a manufacture line is empty. The computer judges a standard manufacturing time period (will be referred to as a “standard time period” hereinafter) from a machine sort functioning as an upper-grade category of a model. This period includes a period for supplying parts. An additional time period is added for transporting the article to the customer and is also added if it is needed for supplying parts beyond the standard time period (will be referred to as a “optional time period” hereinafter). Naturally, the optional time period is zero if the optional parts are supplied within the standard time period. In the present embodiment, the computer automatically seeks the empty date based on the time period including the additional time period. Concrete example of the reservation operation is indicated in FIG. 6 to FIG. 8.

FIG. 6 illustratively shows such a case that the delivery appointed date of the order article is February 1st, and a production reservation of this order article is made on January 1st. A standard time period for completion the article, which is determined, based upon a machine sort, corresponds to 20 days, and the optional time period of 6 days is added. The 26 days correspond to a total day that requires to manufacture the article and to supply parts. As a consequence, a time period up to January 27th from January 1st (namely, 26 days elapse) is set as a time period during which a production reservation cannot be made. Since 2 days are required as a product transport time period up to a supply destination, no production reservation can be made in such a time period defined by 2 days before the delivery appointed date. As a result, January 28th, 29th, and 30th may be obtained as a production reservation available date.

A selection is made of a day when a production reservation can be optionally made during this time period from January 28th to January 30th . This condition is indicated in FIG. 7. It is so determined to sequentially check such an optimum date from dates close to the delivery appointed date. This is because a completed article (end product) should be necessarily restored as an undelivered product when a manufacture of this product is completed earlier than the delivery appointed date. In other words, since the product is brought into a pending condition, a fee of resulting stock is increased.

The reserve is made to the date as near as the requested delivery appointed date so that the production reservation system can be used more widely. However, it may be possible to reserve production as early date as possible so as to reduce the empty date that has no work.

Accordingly, a production line of January 30th is checked at first. A check is done as to how many order articles can be manufactured on January 30th, namely a total number (empty seat) of products that can be manufactured is checked. If one, or more empty seats are available then a production reservation may be made. When there is no empty seat and there are fully reserved seats, a state of a production line on January 29th is checked. In the case that the production line state of January 29th corresponds also to fully reserved seats, another check is made of a production line state of January 28th. As previously explained, an available time period for the production reservation is searched in a retroactive manner. When such an available date for production reservation can be found out, a production reservation result is displayed on the display screen, and also a completion of a production reservation is displayed.

In the case that the available date for production reservation cannot be found out within the reservation available dates, the available date for production reservation is found out from a dates after the reservation available dates. In this case, since the requested delivery appointed date cannot be satisfied, a check is made as to how many days the delivery appointed date is delayed by considering the present plan, or scheme. Another check is made as to whether or not any other adjustments are available, for example, whether or not a manufacture time period involving an additional time period for reconsidering the standard delivery appointed time period can be shortened. It is noted that there is an arranging period for arranging the manufacturing time period and the additional time period to complete the ordered article on time, even if there happens that the requested delivery appointed date is postponed by virtue of the customer's inconvenience, the order is cancelled, or some article have to make up out of schedule. An adjusting the production reservation is not carried out well, an inquiry is made to the manufacture department, and the executions of manufacturing operations may be changed with other articles. When all of these adjustments cannot be carried out, the production of the ordered article have to abandon. However, since there is the arranging period this situation can be avoided.

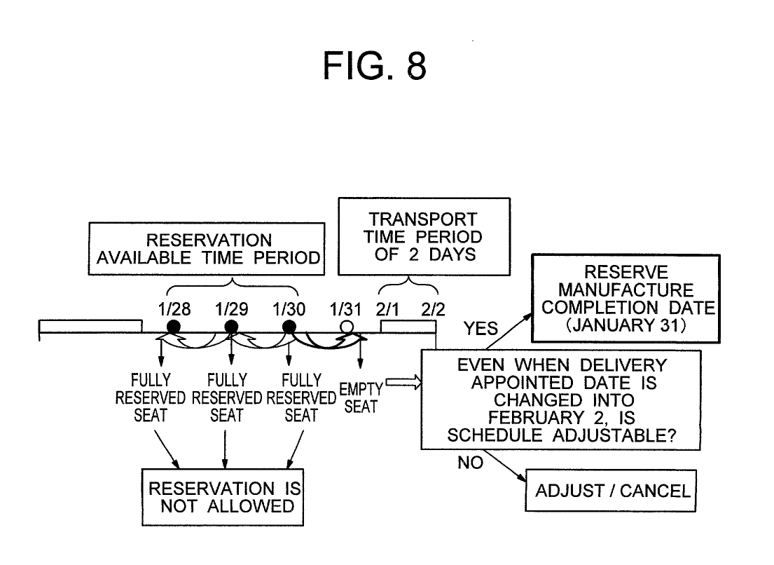

FIG. 8 shows an example of such a case that a product cannot be manufactured until a delivery appointed date. Since all of dates from January 28th up to January 30th of the production reservation subject time period correspond to fully reserved seats, a check is made as to a production condition of January 31st. Since the production condition of January 31st corresponds to an empty seat, if a production reservation is made on January 31st, then the delivery appointed date is postponed until February 2nd. Thus, the computer judges as to whether or not the request of the customer can be satisfied considering the arranging period even when the delivery appointed date is changed to February 2nd, and receives the production on January 31st.

When the production is reserved, the delivery appointed date is determined. This delivery appointed date can be told to the customer immediately and can be utilized as a guaranteed date to the customer. As a result, while the sales activities are effectively supported, the production can be carried out in a high efficiency.

In the reservation operations shown in FIG. 6 to FIG. 8, various sorts of databases (DBs) are used. These databases contain a standard delivery appointed time period data bus DB as to each of machine sorts, a delivery appointed time period database DB as to each of options, a transport time period database DB with respect to each of town/city/prefecture/state, and a production capability database DB for indicating both an available date of production line and an available quantity of production. In the delivery appointed time period database DB with respect to each of the options, even when the same option is utilized, since there is a difference in a total number of days, depending upon the machine sort, additional delivery appointed days are determined in correspondence with the machine sort.

Even in the transport time period database DB with respect to each of the town/city/prefecture/state, since total transport days required for the transport means are different from each other in accordance with the machine sort, additional delivery appointed time period is determined in correspondence with the machine sort. In the production capability database DB, a total production available number is set with respect to each of the machine sort. Also, both the delivery appointed date calendar and the manufacture date calendar are formed with respect to each of the machine sorts.

The sequential operation as to the production reservation operation has been described in the above description. When the sales department enters the reservation, a reservation state flag is set to “reservation under application.” While this reservation state flag is observed, a management department for managing the manufacture (will be referred to as a “management department” hereinafter) confirms as to whether or not an adjustment of a schedule is needed. When the management department judges that the product of the article can be manufactured within the requested delivery appointed date, the management department changes the reservation state flag of this article into “definite.” This flag of changing reservation state is transmitted via either an intra-net or the Internet to such a sales department that has proposed the reservation. Since the “definite” flag is transmitted, the respective relevant departments involving the sales department can grasp the content of this reservation.

The change of this reservation state flag is also indicated on the above-explained delivery appointed date calendar. When the management department changes the reservation state flag into “definite”, a display color of such information as an estimate reference number indicated on the delivery appointed date calendar is changed from, for example, a green color into a black color. In response of this display color change, indications of the respective parts of the product and also the display of the manufacture date calendar for indicating the respective stages are also changed.

Based upon both the information as to the reservation article and the manufacture date calendar for indicating the reservation state, the management department lists up parts required for the reservation article and then, forms a parts completion date calendar with respect to each of these parts. When the parts completion date calendar is accomplished, the contents of this calendar are supplied to the respective parts supply makers. The management department instructs supply time limits of these parts to the respective parts makers in correspondence with the manufacture stages of the order articles including the estimate articles. In other words, the parts makers can also grasp such an optimum condition if which parts may be supplied on which day before the completion date of the product.

The supplied data contain such an order item that the order has been made and the manufactures of the parts have been requested to the parts makers, such an estimated order article that the management department judges it is in a state of “definite” and requests to manufacture the parts to the parts makers although the order has not yet been accepted, and such an article that the sales department merely proposes the reservation. A formal order to a parts maker may be issued from an order issuing system at timing of a predetermined time limit. Such an article made at a stage of reservation proposal that implies an order of the article can be received in future is also supplied as reference data to a parts supply maker. As a result, the parts supply maker may predict a demand of the parts manufactured by the own firm.

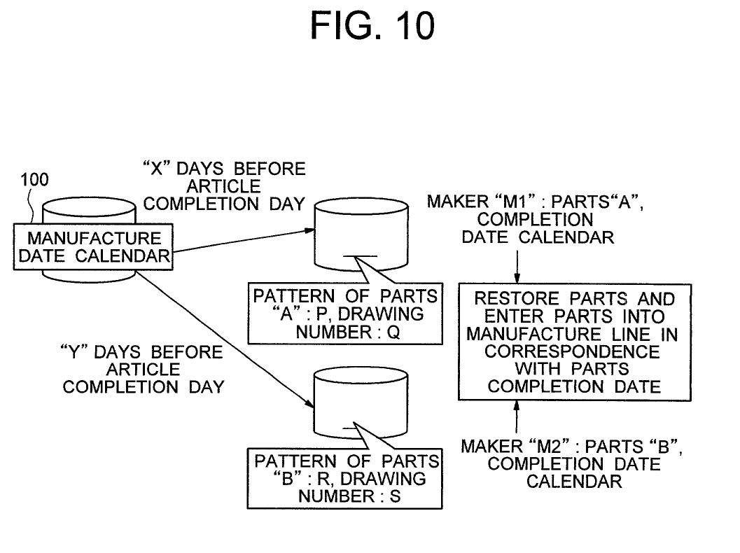

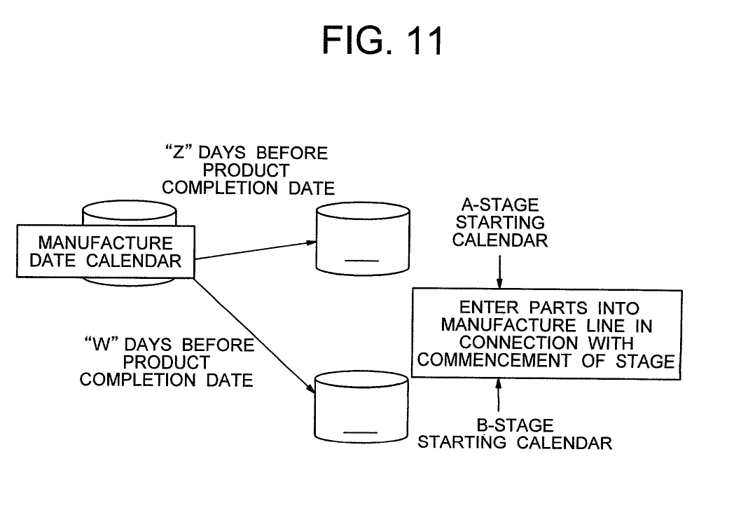

As represented in FIG. 10, the parts makers look up such a parts completion date calendar which is formed from the manufacture date calendar 100 and is supplied to these parts makers. As a result, a parts maker “M1” supplies parts “A” indicated on a drawing “Q” in the form of a pattern “P” up to the day “X” before the completion date of the product. With respect to the same order article, parts “B” indicated on a drawings “S” are supplied in the form of a pattern “Q” to another parts maker “M2”, up to the day “Y” before the completion date of the article. These parts “A” and “B” are sent to order issuer for the parts makers M1 and M2 on the respective designation dates, and thus, are timely supplied to manufacture lines of this order issuer. The order issuer goes to the respective parts makers so as to restore these parts which have been ordered to this parts maker, while using a carrier car.

In FIG. 10, a pattern implies a total number, a use of an option, and specifying of a material. The parts makers may previously grasp that the parts should be supplied by employing which pattern. As to a drawing, if there is such a drawing which has been previously used, then an instruction is made to use this previously-used drawing. In the case that a drawing corresponds to a new drawing and is not owned by a parts maker, this new drawing may be supplied from an order issuer to the parts maker via such an electronic communication means whose security is confirmed, for example, the Internet. While this new drawing is formed by a designer of an order issuer, if there is such a drawing which has been previously drawn, then this drawing is automatically issued from a drawing database and the issued drawing is supplied to the parts maker.

Each of stages of a production line is also formed based upon the manufacture date calendar. This sequence is indicated in FIG. 11. While either a manufacturing worker, assembling worker or a manager of these workers observes a stage calendar which is formed from the manufacture date calendar, the workers or the manager may grasp a progress of the respective stages. Namely, a worker of a stage “A” is required to accomplish the stage up to the day “Z” before the completion date of the article, and a worker of another stage “B” is required to complete the stage up to the day “W” before the completion date of the article. The workers of these stages start to perform the works of the respective stages in order that the articles of these stages should be completed until designated dates in response to this instruction. In this case, the parts which have been ordered to the parts makers are supplied from these parts makers in correspondence with progress of the stages.

In accordance with this embodiment even in the case of order-accepted production, a work load of day by day in the manufacturing stages, and also in the assembling stage, is equalized and the parts are supplied just in time (JIT), it is possible to treat the order-accepted production such as a line production of a mass production. In this embodiment, the manufacture starting dates of the parts makers and the stage starting dates of the manufacture lines are not specified, however, it is possible to specify in the manufacturing date calendar. In that case, it can be reduced the errors caused by mishandling of a stage schedule.

At the time when the delivery day and time can be correctly grasped, the sales department enters an address, a place, and a person who is in charge as to a delivery destination, and also a delivery time instant into the generating part of the production reservation. The management department confirms all of the above-described data entered by the sales department, and then, manages shipping of the article. When the article is completed of delivering, the management department inputs such a flag that the article has been delivered from the manufacturing factory. Entering of this flag may be executed by reading a bar code attached to the product by operating a bar code input appliance provided in a product delivery center.

While the bar code data is inputted to the generating part of the production reservation calendar of the production reservation system described in this embodiment, the information of the shipping flag is fetched into the manufacture date calendar and the delivery appointed date calendar. When this information of the shipping flag is entered, the information as to the shipped product is displayed on the respective calendars while display colors thereof are changed. The sales department acquires the shipping information from this production reservation system, and prints out this acquired shipping information to provide the printed result to the delivery destination. As a result, the early payment for the refrigerator may be realized.

In accordance with this embodiment, since the production reservation can be made to the respective manufacturing stages at the time when the estimate information is inputted by the sales department, the work lord at the respective stages can be equalized throughout the year. The deviation between the desirable deliveries appointed date of the customer and the actual delivery appointed date can be reduced. Furthermore, while the parts supply can be progressed and promise of the product delivery appointed date can be strictly kept, the payment can be progressed and thus, the effective supply chain management system can be constructed.

The Internet is utilized between the manufacturing maker corresponding to the order issuer and both the sales department and the parts makers in the above-described embodiment, on the other, the intra-net is used among the management department for planning the stages within the manufacturing maker, the manufacture department, and also the design department. In addition, the estimate ordering system the order information system the generating part of a production reservation calendar is stored in a server that is installed in the manufacturing maker. Each of the above-described systems may be operated on the same server, or may be distributed to several servers so as to be stored thereinto.

The transmissions of the information between the manufacturing maker and either the sales department or the parts makers may be carried out by employing a public telephone line and the like instead of the Internet or intra-net. As explained above, since the publicly-employed information transmission means is employed, the information can be commonly shared in a simple manner and in an earlier stage, the production schemes of the respective departments can be planned in an earlier stage, and also, the adjustment time required for the planning can be reduced.

In accordance with the above-described embodiment, in such a supply chain management system that the production of the manufacture department is managed, the orders to the parts supply makers are managed, and also the production of these parts supply makers are managed based upon the reservation provided from the sales department of the order-accepted production, the sales activities defined from the estimate operation up to the order reception can be grasped by both the manufacture department and the parts supply makers, so that the grasped sales activities can be utilized so as to predict demands in the earlier stage. Also, since the sales department reserves the manufacture line based on an empty seats information sharing with related divisions, the production equalization throughout the year can be automatically carried out. Furthermore, the parts which are used in the order-accepted production can be effectively obtained form the parts makers.

In accordance with this embodiment, since the sales department can confirm the delivery appointed date when the production is reserved, the sales activities made by this sales department can be readily expanded. Even when the sales department cannot receive the formal order, the sales department can cancel a related estimate in an earlier stage within such a time period allowed for the cancellation, the waste work by the manufacture department can be avoided. The sales department reserves the production of only such an article having a high order certainty level, which is selected from a very large amount of estimate information. As a result, probability of demand predictions can be increased, so that the parts and the resources required in the manufacture department can be prepared in an earlier stage, the production line can be prepared in an earlier stage.

Within such a time period during which reservations and orders made by the sales department are concentrated, the production can be carried out in advance in correspondence with the yearly productivities, so that the work load can be equalized and the managing efficiency may be improved. Based upon the demand prediction information for near future, the parts and the resources may be prepared in advance. In addition, it can be used the above-explained servers in subsidiary companies or licensed companies.

As previously described, in accordance with the present invention, since the production reservation system provides a production reservation calendar, the sales department can reserve a production at the time when the sales department can acquire the estimate information. The sales department can reserve the manufacturing stages in the production line of the production department, so that both the concentration of the products and the empty seats of the production calendar shall be avoided. Thus, the equalization of the products can be realized and the products can be delivered at the time the customer desires.

This invention may be practiced or embodied in still other ways without departing from the spirit or essential character thereof. For instance, while in the illustrated preferred embodiments, a refrigerator may alternately be a compressor or a pump. The preferred embodiments described herein are therefore illustrative and not restrictive, the scope of the invention being indicated by the appended claims and all variations which come with the meaning of the claims are intended to be embraced therein.

What is claimed is:

1. A production reservation system for reserving production of an article based upon an estimate information of a sales department, comprising:
a supporting system for estimating, in which the sales department inputs the estimate information; and
a generating part of a production reservation calendar in which a production schedule in a production reservation calendar is reserved in response to the estimate information inputted in said estimate supporting system, wherein a mass of production that is determined based on a capability of production in the production department has inputted to the production calendar in advance.

2. A production managing system as claimed in claim 1, wherein the estimate information from the sales department is inputted into said estimate supporting system by employing either the Internet or a public telephone line.

3. A production reservation system as claimed in claim 1, wherein the estimate information from the sales department contains a certainty degree of an order, and said generating part of a production reservation calendar calculates the production schedule based upon said certainty degree of the order and enables to show a completion date of the article at a time the sales department inputs the estimate information.

4. A production reservation system as claimed in claim 1, wherein said generating part of a production reservation calendar comprises a manufacture date calendar which is generated based on the estimate information inputted to said support system for estimate, and generates a parts completion date calendar which is supplied to a parts maker with employment of both a providing period assigned by respective parts and said manufacturing calendar.

5. A production reservation system as claimed in claim 1, wherein said generating part of a production reservation calendar comprises a manufacture date calendar which is generated based on the estimate information inputted to said support system for estimate, and generates a manufacture stage calendar which is supplied to a manufacture department with employment of said manufacture date calendar.

6. A production reservation system for reserving production of an article based upon estimate information of a sales department comprising:
a supporting system for estimate which stores thereinto the estimate information containing a requested due date inputted by the sales department; and
a generating part of a production reservation calendar reserving a production schedule in a production reservation calendar based on the estimate information inputted to said supporting system for estimate,
wherein said generating part of the production reservation calendar reserves the production into one of empty seats of the production reservation calendar which is calculated based on a standard time period required for supply of parts and manufacturing set up to a standard article, an optional time period needed for a modified article modified from the standard article and delivery time period for delivering the article.

7. A production reservation system as claimed in claim 6, wherein said generating part of the production reservation calendar reserves a production into one of the empty seats located before the requested due date by more than the delivery due date and located after elapsing a summed period of the standard time period originated from inputting the estimate information by the sales division and the optional time period.

8. A production reservation system as claimed in claim 7, wherein said generating part of the production reservation calendar reserves the production into an empty seat of the production reservation calendar which is located nearest the requested due date.

9. A production reservation system as claimed in claim 6, wherein said generating part of the production reservation calendar reserves the production into an empty seat of the production reservation calendar which locates nearest the requested due date and after the requested due date when no empty seat is found before the requested due date.

10. A production reservation system as claimed in claim 1, wherein in the case that the reservation information is changed into “no order”, said generating part of a production reservation calendar cancels the reservation and reserves another article.

11. A production reservation system as claimed in claim 2, wherein in the case that the reservation information is changed into “no order”, said generating part of a production reservation calendar cancels the reservation and reserves another article.

12. A production reservation system as claimed in claim 3, wherein in the case that the reservation information is changed into “no order”, said generating part of a production reservation calendar cancels the reservation and reserves another article.

13. A production reservation system as claimed in claim 4, wherein in the case that the reservation information is changed into “no order”, said generating part of a production reservation calendar cancels the reservation and reserves another article.

14. A production reservation system as claimed in claim 5, wherein in the case that the reservation information is changed into “no order” said generating part of a production reservation calendar cancels the reservation and reserves another article.

15. A production reservation system as claimed in claim 6, wherein in the case that the reservation information is changed into “no order”, said generating part of a production reservation calendar cancels the reservation and reserves another article.

16. A production reservation system as claimed in claim 7, wherein in the case that the reservation information is changed into “no order”, said generating part of a production reservation calendar cancels the reservation and reserves another article.

17. A production reservation system as claimed in claim 8, wherein in the case that the reservation information is changed into “no order”, said generating part of a production reservation calendar cancels the reservation and reserves another article.
